(19) United States
(12) Patent Application Publication
(10) Pub. No.: US 2008/0217399 A1
(43) Pub. Date: Sep. 11, 2008

(54) System and method for controlling usage of a payment card

(76) Inventor: Eric Leblanc, St-Jean de Matha (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/714,800

(22) Filed: Mar. 7, 2007

(51) Int. Cl. G06K 5/00

(52) U.S. Cl. 235/380; 705/44

(57) ABSTRACT

A system and method for controlling usage of a payment card by a cardholder using a cardholder telephony device is provided. The cardholder registers the payment card and the cardholder telephony device and defines cardholder default limits for the card. During subsequent usage of the card, an authorization computing device connected to the cardholder telephony device by a network verifies that the default limits for the card are not exceeded. If the default limits are exceeded, then a cardholder authorization for the usage of the card must be provided by the cardholder form the cardholder telephony device. The cardholder may also pre-authorize usage of the card in excess of the default limits.

### FIELD OF THE INVENTION

The present invention relates to payment card authorization methods and systems, and is more particularly concerned with a method and system for controlling usage of a payment card.

### BACKGROUND OF THE INVENTION

Automated systems and methods for controlling usage of a payment card by a cardholder thereof are well known. Typically, such systems allow financial institutions, such as banks or the like, which issue the payment cards to verify, a number of pre-determined parameters and limits established by the financial institutions upon presentation of a card number associated with the payment card to a payment terminal device, in which the payment card is typically inserted or swiped. Such parameters and limits typically include, for example, spending or credit limits and allow the financial institution to verify the identity of the user and limit the usage of the cards for payments to reduce the risk of fraud.

For example, U.S. Pat. No. 6,993,510 issued to Guy et al. on Jan. 31, 2006 teaches a system and method for controlling usage of payment card accounts or the like, having a database for storing a permanent cardholder ID associated with each cardholder, an account ID for each account accessible by the cardholder, a card number for the card appearing on each card, and a role identifier. When a transaction is conducted at a terminal, the card number is provided to a database management system, which then can retrieve the cardholder ID and the account ID for the account being accessed. If a card is lost, stolen or otherwise rendered unusable, a security suspense record is inserted into the database in an account ID filed associated with the affected card number. When the card number associated with the lost or stolen card is provided to the system, the security suspense record is retrieved and causes the transaction to be invalidated. All other card numbers and cards associated therewith for the affected account can continue to be used, thus eliminating the need to close the account. The role identifier permits account criteria (e.g., financial responsibility, credit limits, purchase restrictions, etc.) to be established for individual cardholders.

As another example, U.S. Pat. No. 7,096,192, issued to Pettitt on Aug. 22, 2006 teaches a method and system for controlling usage of a credit card for a transaction, such as a purchase, by a cardholder over the Internet. The method and system comprises obtaining credit card information relating to the transaction from the consumer; and verifying the credit card information based upon a variety of parameters, such as card usage history, spending limits and the like. The variety of parameters are weighted so as to provide a merchant with a quantifiable indication of whether the credit card transaction is fraudulent.

Unfortunately, systems and methods such as those described in the prior art references cited above, while allowing for verification of limits and parameters established by the financial institutions, do not allow easy establishment by the cardholder of cardholder limits for usage of the payment card. Such cardholder limits may be desired by cardholders who may wish, for purposes of further reducing the risk of fraud, to place more stringent limits on the use of the payment cards than those established by the issuing financial institutions. Further, such systems and methods do not typically allow cardholders to easily modify or disable cardholder limits established by the cardholders.

Accordingly, there is a need for an improved system and method for controlling usage of payment cards by cardholders using cardholder default limits defined by the cardholders.

### SUMMARY OF THE INVENTION

It is therefore a general object of the present invention to provide an improved system and method for controlling usage of payment cards by cardholders using cardholder default limits defined by the cardholders.

An advantage of the present invention is that the cardholder default limits for a payment card can be defined and modified rapidly by a cardholder using a cardholder telephony device.

Another advantage of the present invention is that verification of the cardholder default limits and cardholder authorization of then usage of the card may be effected from a cardholder telephony device issued to the cardholder.

A further advantage of the present invention is that the usage of the card in excess of the cardholder default limits may be pre-authorized by the cardholder from a cardholder telephony device issued to the cardholder.

According to a first aspect of the present invention, there is provided a method for controlling usage of at least one cardholder payment card by a cardholder for purchases using a cardholder telephony device of the cardholder, the payment card being issued to the cardholder by a financial institution, said method comprising the steps of:
verifying that the usage does not exceed at least one cardholder default limit up to which a cardholder authorization for the usage is not required, each cardholder default limit being predefined by the cardholder;
if the at least one cardholder default limit is exceeded, requesting said cardholder authorization for the usage using the cardholder telephony device;
declining the usage if said cardholder authorization is not granted; and
if the usage is not otherwise declined by the financial institution, authorizing the usage.

In a second aspect of the present invention, there is provided a system for controlling usage of at least one cardholder payment card by a cardholder for purchases using a cardholder telephony device of the cardholder connected to a telephony enabled first network, said system comprising:
an authorization computing device for processing, the authorization computing device and the cardholder telephony device being connectable to one another by said first network; and
a first database accessible by said authorization computing device and containing a respective card number for the card and respective cardholder default limits for the card defined by the cardholder, said authorization computing device verifying that the usage does not exceed at least one cardholder default limit up to which a cardholder authorization for the usage is not required, requesting the cardholder authorization for the usage using the cardholder telephony device if the said cardholder default limit is exceeded, declining the usage if the cardholder authorization is not granted; and, if the usage is not otherwise declined by the financial institution, authorizing the usage.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, in which similar references used in different Figures denote similar components, wherein:

FIG. 1 is a system view of an embodiment of a system for controlling usage of a payment card in accordance with the present invention;

FIG. 2 is a data structure view showing data structures for the system shown in FIG. 1;

FIG. 3 is a flowchart showing an embodiment of a method for controlling usage of a payment card in accordance with the present invention method;

FIG. 4 is a flowchart showing the steps for registering the card during the registration step of the method shown in FIG. 3;

FIG. 5 is a flowchart showing the steps for the cardholder authorization granted step of the method shown in FIG. 3; and

FIG. 6 is a flowchart showing the steps for the cardholder pre-authorization step of the method shown in FIG. 3.

### DETAILED DESCRIPTION OF THE PREFERRED EMBODIMENTS

With reference to the annexed drawings the preferred embodiments of the present invention will be herein described for indicative purpose and by no means as of limitation.

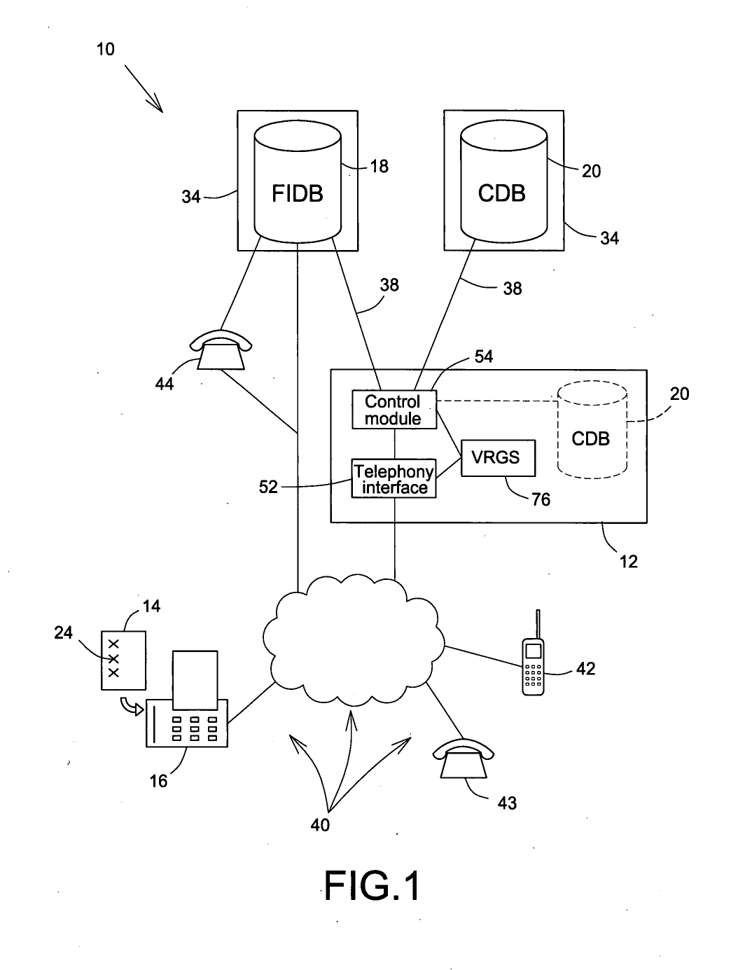

Referring to FIG. 1, there is shown an embodiment of a system, shown generally as 10 for authorizing usage of a payment card 14 in accordance with a first embodiment of the present invention. As shown, the system 10 includes at least one authorization computing device (ACD) 12, which is responsible for authorizing or declining, and thereby controlling, usage of a payment card 14 for a transaction, such as a purchase, when the card 14 is presented at a payment terminal device (PTD) 16, typically situated at a merchant's premises, for obtaining authorization for the transaction. The ACD 12 is also connected to a financial institution database (FIDB) 18 and a cardholder database (CDB) 20, as well as to a first, telephony enabled network, shown generally as 40, upon which telephony enabled connections between the ACD 12, cardholder telephony devices (CTD) 42, 43 of cardholders, financial institution telephony devices 44 of financial institutions, and PTDs 16, may be established for providing both voice and data communications therebetween for providing authorization of usage of the card 16.

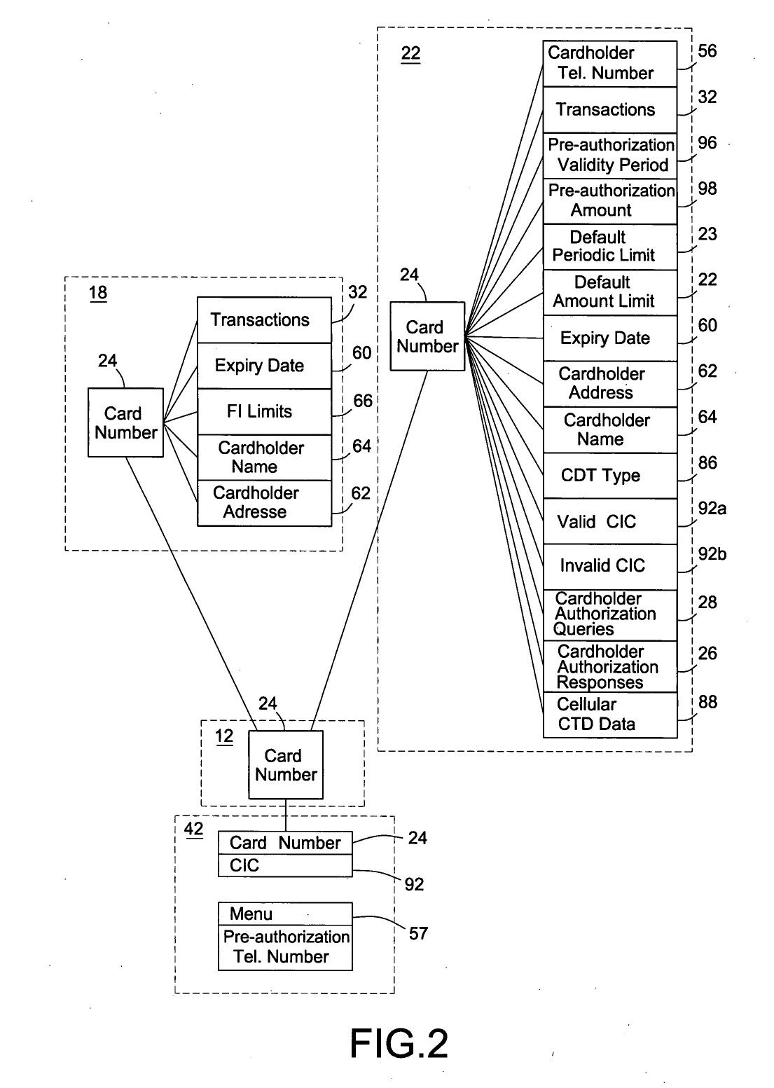

Referring now to FIGS. 1 and 2, the FIDB 18 is typically operated by a financial institution (FI) which issues the payment card 14 to the cardholder and which has stored therein, among the payment card number 32 and the expiry date 60 for the payment card 14, financial institution limits 66 on usage of the card 14 defined by the FI issuing the card 14, the cardholders name 62, the cardholder's address 64, and credit and transaction records 32 authorized or declined by the ACD 12 or the FI, related to the cardholder and the card 14. The CDB 20 contains, for each payment card 14 registered for the cardholder in the system 10, the expiry date 60 of the cardholder default usage limits 22, 23 the payment card number 24, predefined cardholder authorization responses 26 and queries 28 predefined by the cardholder, cardholder telephone numbers 56 for CDTs 42, 43 associated with the card number 24, the cardholders name 62, the cardholders address 64, a CDT type 86 indicating the type of CDT 42, 43 for the CDT telephone number 56, predefined cardholder default usage limits 22, 23 defined by the cardholder, transaction records 32 of transactions authorized or declined by the ACD 12, preauthorization amounts 98 for any cardholder pre-authorizations, shown generally as 99, for purchases, pre-authorization validity periods 96 for any cardholder pre-authorizations 99, a currently valid randomly generated CTD cellular identification code (CIC) 92a for each cellular CTD 43 associated with the card number 24, and, when applicable, at least one invalid CIC 92b previously generated for a programmable cellular CTD 42 associated with the card number 24. The payment card number 24 serves as a key, or link, to all other data 22, 23, 26, 28, 56, 60, 62, 64, 86, 92, 94, 96, 98 stored in the system 10 which are associated with the card number 24 in the databases 18, 20. The databases 18, 20 may be resident on the ACD 12 itself, or, as shown, on other computing devices (CDs) 34, for example a financial institution computing devices FICD 34 operated by the FI, connected to the ACD 12 by data links 38, which may be network links connecting the ACD 12 to the CDs 34 over the first network 40 or, if desired, a second, data enabled network, not shown.

The CTDs 42, 43, as well as optional financial institution telephony devices 44, are used for providing cardholder authorizations, banking authorizations, and cardholder pre-authorizations for usage of the card 14, as well as registering cards 14 for use with the system 10. The telephony devices 42, 43, 44 may be any telephony enabled device through which voice and data may be transmitted over the network 40 and to which respective telephone numbers 56 may be assigned. Accordingly, the CTDs 42, 43 may include wireline/landline telephony devices 43, such as conventional landline telephones and and personal computers having telephony capability, or programmable cellular enabled telephony devices 42, such as programmable cellular telephones and programmable personal digital assistants (PDA) having telephony capability. The FITD 44 may also be a wireline/landline telephony devices or cellular enabled telephony devices, a wireline telephony device is preferred. Communications between the PTD 16 and the ACD 12, as well as between the FITDs 44, CTDs 42, 43 and ACD 12 are managed by a telephony interface 52. Notably, the ACD 12 may, via the telephony interface 52 initiate and receive calls, i.e. connection requests, between the ACD 12 and the telephony 42, 43, 44, as well as between the ACD 12 and the PTD 16. To this end, the ACD 12 may be assigned one or more ACD telephone numbers 57 from which the ACD 12 may receive and initiate connection requests, i.e. telephone calls, to and from the telephony devices 42, 43, 44, and PTD 16. The ACD 12 may also serve as an FITD 44, and any calls to the FITD 44 for registering cards 14, preauthorizing transactions, or authorizing transactions are typically rerouted from the FITD 44 to the ACD 12. In particular, the ACD 12 will typically have at least one ACD telephone number 57 which is assigned as a pre-authorization telephone number 57 which may be dialed by a cardholder from a CTD 42, 43 to establish a telephonic connection therebetween for conducting cardholder pre-authorizations 99.

Configuration of the system 10 and authorization of usage of the cards 14 using the telephony devices 42, 43, 44, and PTD 16 are controlled by a number of modules, including the databases 18, 20, telephony interface 52, as well as a control module 54, which may be resident on the ACD 12 or on a FICD 34 operated by the financial institution. The control module 54 accesses and updates the databases 18, 20, instructs the telephony interface 52 to establish connections between the ACD 12 and the telephony devices 42, 43, 44 and PDT 16, controls the flow of data over the connections, and manages all of the authorizations and pre-authorizations 99 for usage of the card 14. Thus, it is the control module 54 which, ultimately, authorizes or declines usage of the card, typically by sending a message authorizing or declining the usage to PDT 16 to which the card 14, and more specifically the card number 24, is presented for usage of the card 12. The PDT 16 may be any device through which the payment card number 32 and any other required information for a purchase, such as a payment card expiry date, payment amount for a transaction, and a personal identification number (PIN) associated with the card may be entered and transmitted over the network 40. Thus, the PDT 16 may be a conventional payment terminal in which the card 14 is swiped and with which a payment amount, and possibly a PIN, is entered on a keypad thereof, not shown. The PDT 16 could also be a personal computer connected to the network. The network may be any telephony enabled network 40, including the Internet, and may have both wireless, for example cellular, and wireline/landline components. The payment card 14 may be any card issued by a financial institution for effecting transactions, and notably payments for purchases, including, but not limited to, credit cards, charge cards, smart cards, and debit cards. The ACD 12 and other CDs 34 are, preferably, personal computers.

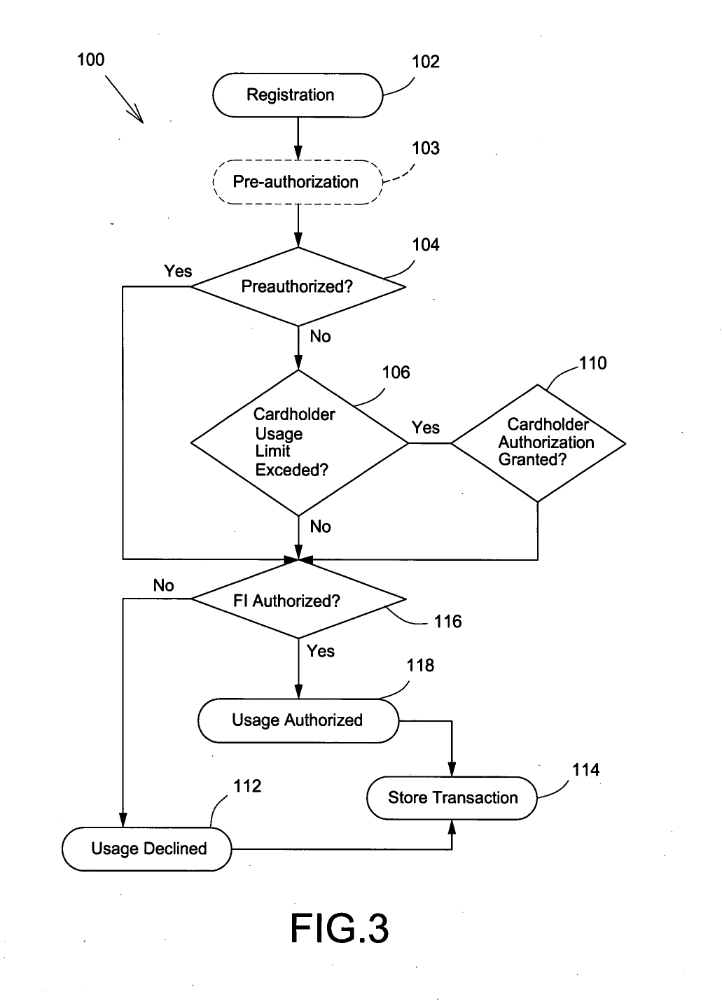

The use of the system 10 for controlling usage of the payment card 14 is now explained in further detail with reference to FIG. 1, and FIGS. 3-6, which detail a method, shown generally as 100, by which usage of the payment card 14 may be controlled, i.e. authorized or declined. Referring to FIGS. 1 and 3, therein is shown a method, shown generally as 100, by which usage of the payment card 14 for at least one transaction, typically a purchase, is controlled using the cardholder telephone 42, 43. As shown at step 102, prior to conducting any authorizations for purchases, the card 14 is registered, typically with the financial institution or a service provider engaged by the financial institution for providing the system 10 or method 100 thereto. The registration step, explained in greater detail below, typically involves providing for storage in the CDB 20, by the cardholder, of the card number 24, telephone numbers 56 for the cardholder telephones 42, 43, predefined cardholder default usage limits 22, 23, and predefined authorization queries 28, predefined authorization responses 26, the cardholder's name 62, cardholder address 64, and possibly the expiry date 60 of the card 14, and the CTD type 86 for each CTD 42, 43 registered with the card 14. The card number 24, the cardholder name 62, cardholder address 64, and the expiry date 60 may also be stored during the registration step on the FIDB 18. However, as the FI has issued the card 14, the financial institution will typically already have access to data elements 60, 62, 64, and these elements may not necessarily have to be specifically added to the FIDB 18 during the registration step 102, as they will be identifiable by referencing the card number 24.

Once the card 32 has been registered at step 102, pre-authorizations 103 and authorizations 110 of usage of the card for purchases or other transactions may be undertaken by the cardholder using the CTD 42, 43. Typically, when the card 14, and more specifically the card number 24, is presented or entered at a PTD 16 for usage for a transaction, the PTD 26 transmits the card number 24 to the ACD 12, which performs, at step 104, a verification of whether the usage has been pre-authorized by the cardholder at step 103, explained in greater detail below. If the usage is not pre-authorized, the ACD 12 verifies whether, at step 106, the requested usage exceeds at least one predefined cardholder default usage limit 22, 23, and for which a cardholder authorization for usage of the card 14 is automatically granted by the ACD 12, is exceeded. The cardholder default usage limits 22, 23 typically include a cardholder defined cardholder default amount limit 22 and, if desired by the cardholder, a cardholder defined cardholder default periodic limit 23. These cardholder default usage limits 22, 23 are defined by the cardholder during the registration step 102 and stored as numerical values in the CDB 20.

Referring still to step 106, the default amount limit 22 is the maximum monetary amount for a single purchase for which a cardholder authorization is deemed to be automatically granted by the Cardholder by the ACD 12, i.e. for which, subject to the default periodic use limit 23 or any pre-authorizations overriding the default amount limit at step 103, a cardholder authorization by the cardholder using a CTD 42, 43 will not be required. The default amount limit may be any amount of money that does not exceed any financial institution limits 66, such as credit limits or the like, imposed by the FI. The default periodic limit 23 is the maximum number of purchases not exceeding the default amount limit 22 or any pre-authorizations granted by the cardholder at step 103, in a predefined default period of time, for which a cardholder authorization using a CTD 42, 43 will not be required by the ACD 12. Thus, even if the payment amount for a purchase does not exceed the default amount limit 22, if the cardholder has opted to specify a default periodic limit 23 during the registration step 102 and the maximum number of purchases not exceeding the default amount limit 22 for the predefined usage period has already been reached, then a cardholder authorization will not be deemed to automatically granted by the ACD 12 and the ACD 12 will require that the cardholder provide a cardholder authorization using a CTD 42, 43 at step 110. The default period of time and the maximum number of purchases not exceeding the default amount limit 22 allowed therein are optionally defined by the cardholder during the registration step 102.

If, at step 106, it is determined by the ACD 12 that any of the default usage limits have been exceeded, then the ACD 12 will, at the cardholder authorization step 110, reference the CDB 20 with the card number 24 to obtain the cardholder telephone number 56. Still at step 110, using the telephony interface 52, the ACD 12 dials the CTD 42, 43 to establish a telephonic connection therewith over the network 40 and requests that the cardholder provide, with a cardholder query 28, a cardholder authorization response 26, both 26, 28 being predefined by the cardholder during the registration step 102, for the usage of the card 12 using the CTD 42, 43. The cardholder authorization response 26 may be, for example, a “yes/no” response, provided either vocally from the CTD 42, 43 or from a keypad of the CTD 42, 43. The cardholder authorization response 26 may also be, possibly in addition to a keypad or vocal “yes/no” response, a cardholder authorization code, which, if provided from the CTD 42, 43, will constitute the cardholder authorization for the transaction. The cardholder authorization code is predefined by the cardholder during the registration step 102 and may be provided, as further defined by the cardholder during the registration step 102, either vocally from the CTD 42, 43 or from a keypad of the CTD 42, 43. If the cardholder authorization response 26 is not provided, then the cardholder authorization is deemed by the ACD 12 to have been declined, i.e. not granted, by the cardholder. If the cardholder authorization response 26 is provided, then the cardholder authorization is deemed by the ACD 12 to have been granted by the cardholder.

If the cardholder authorization is not granted, then proceeding to step 112, the usage is declined, i.e. refused. A transaction record 32 of the transaction, possibly with a unique transaction code therefore, is then communicated by the ACD 12 to at least one of, and preferably both, the CDB 20 and the FIDB 18, where it is stored in association with the card number 32 at step 114. The record 32 may include, for example, an indication that the usage of the card 14 was declined and the reason therefore, the amount requested, an identifier for the PTD 16 or the merchant at which the transaction was requested, and the time and date of the requested transaction. A copy of the record 32 may also be provided to the cardholder in the form of a paper or electronic receipt at step 114.

If it is determined by the ACD 12 at step 106 that the cardholder authorization has been granted, or if the ACD 12 determined that the usage has been pre-authorized by the cardholder at step 104, then the ACD 12 verifies, at step 116, that the usage is authorized by the financial institution, i.e. that at a financial institution authorization has been granted by the FI. Typically, this involves verifying that the usage does not exceed a financial institution limit 66. It may also involve verifying whether the FI has identified the card 14 as stolen or otherwise fraudulent. The financial institution limit 66, for example a conventional credit card or debit card spending limit, is defined by the financial institution and stored in the FIDB 18 in connection with the card number 24, as is the card status 67 of the card 14 as stolen or fraudulent. Step 116, however is optional to the extent that financial institution limits 66 and card status 67 are already verified by conventional system and methods for authorizing usage of cards 14 that are currently used by FIs. Further, it is possible that the FI may issue a card 14 that is not subject to any predefined financial institution limits 66. If the usage is not approved by the financial institution at step 116, i.e. a financial institution authorization is declined, then the usage is declined by the ACD 12 and the transaction record 32 recorded, as described above for steps 112 and steps 114. Otherwise, the ACD 12 deems the usage to be approved by the FI, i.e. that a financial institution authorization has been granted.

If it is determined at step 104 that the usage has been pre-authorized, or that no cardholder default usage limits 22, 23 have been exceeded at 106, or the cardholder has granted the cardholder authorization at step 110, then, provided the usage is not otherwise declined, for example at step 116, the usage is authorized by the ACD 12 at step 118. A transaction record 32 of the usage and authorization thereof is then generated and stored at step 114.

It should be noted that the records 32 generated at step 114 may be used in a variety of ways for security and fraud prevention purposes. For example, if the cardholder declines to grant cardholder authorization for usage of the card 14 too many times in a given period of time, then an alarm could be generated at the ACD 12 for invalidating the card 14. The parameters used by the FI for evaluating the likelihood of fraud based on the transaction records generated at step 114 are typically defined by the FI itself.

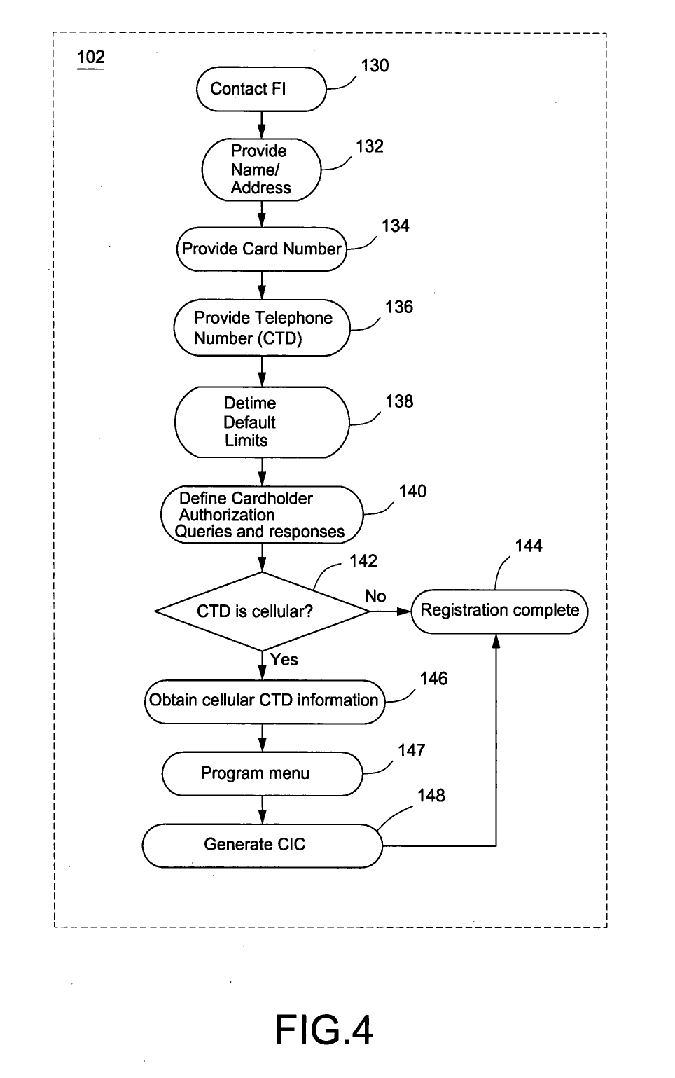

To better aid the reader in understanding the registration step 102, reference is now made to FIG. 4, which shows the steps performed for registering the card 14 at step 102, in conjunction with FIGS. 1, 2, and 3. To register a card 14, the cardholder contacts the FI at step 130 and requests registration of the payment card 14. Step 130 may involve, for example, physically attending premises of the FI, telephoning the FI, or contacting the FI using a computing device. However, the preferred method for contacting the FI is via telephone, and notably a landline CDT 43, possibly by dialing a telephone number 56 for a FITD 44. For security purposes, the initial registration, or subsequent modifications thereto, may not be completed from a cellular CDT 42.

Proceeding to step 132, once the cardholder is in contact with the FI, the FI, and more specifically a person designated thereby, receives the information required for registration from the cardholder. Specifically, and notably for cardholders that have not already registered a card 14, the cardholder provides the FI with the cardholder's name 62 and cardholders address 64 at step 132. Proceeding to step 134, the cardholder provides the card number 24, and possibly the expiry date 60, if applicable, of the card 14 to the FI. Still at step 134, the card number 24, the cardholder name 62, and the cardholder address 64 are transmitted by the FI to the ACD 12 for storage in the CDB 20 and, possibly, the FIDB 18 if not already present therein. At step 136, the cardholder telephone number 56 for the CTD 42, 43 from which the cardholder may grant cardholder authorizations and pre-authorizations 99, for the purposes of steps 110 and 103, is provided and entered into the CDB 20. At this step 136, it is also specified by the cardholder whether the cardholder telephone is a cellular CTD 42 or a landline CTD 43, and this information is stored by the ACD 12 in a CTD type field 86 in the CDB 20. There may be, if desired, multiple CTDs 42, 43 and respective telephone numbers 56 therefor provided for each card 14.

Next, at step 138, the cardholder provides, i.e. defines, the predefined cardholder default usage limits 22, 23 for the card 14, described previously, and which are entered into the CDB 20. The cardholder initially specifies the default amount limit 22 for the card 14, which is compulsory. Then, if desired, the cardholder specifies the default periodic limit 23 by specifying an a default period of time period 68 and a maximum number of purchases not exceeding the default amount limit 22 that may be undertaken within the default time limit without the cardholder having to provide a cardholder authorization using the CTD 12 at step 110. The default period of time may be, for example, a period of hours, a day, a plurality of days, months, etc. and will typically renew at the end of each default time period. For example, the cardholder could specify that the default amount limit is 50 dollars, that the maximum number of purchases is three (3), that the default period of time is one day, and that the default periodic limit will automatically renew at the end of every day, i.e. daily. Thus, the cardholder may effect up to three purchases having a value of 50 dollars or less per day without having to grant a cardholder authorization at step 110. Any purchase over 50 dollars or additional purchases up to 50 dollars in a single day beyond the first three purchases up to 50 dollars during that day will, unless pre-authorized at step 103, require a cardholder authorization from the CTD 42, 43 at step 110. The limits 22, 23 transmitted from the FI to the ACD 12 which stores them on the CDB 20.

Next, at step 140, the cardholder defines the cardholder authorization queries 28 and respective cardholder authorization responses 26 therefor which must be furnished to the ACD 12 in response to the queries 28 using the CTD 42, 43 to grant a cardholder authorization for usage of the card 14 at step 110 or to grant a cardholder pre-authorization at step 103. The cardholder may define as a cardholder authorization query 28 a request that the cardholder enter a cardholder authorization code as the cardholder authorization response 26, in which case the cardholder provides the cardholder authorization code, either vocally or using a keypad on the CTD 42, 43, which is stored by the ACD 12 on the CDB 20 as the cardholder authorization response. Also as mentioned previously, the cardholder may also define how the cardholder authorization query 28 will be communicated to the cardholder on the CTD 42, 43, and how the respective response 26 therefor will be provided by the cardholder using the CTD 42, 43. For example, the cardholder elect to have the ACD 12 make the cardholder authorization query 28, for example requesting entry of the cardholder authorization code, vocally by generating a vocal request therefore using a optional (VRGS) 76, optionally installed on or connected to the ACD 12, which is transmitted to the cardholder over the network 40 to the CTD 42, 43. The cardholder could also elect, especially for cellular CTDs 42, to have the ACD 12 make the cardholder authorization query 28 as a text message displayed on a display of the CTD 42, 43. Alternatively, the cardholder may simply define the cardholder authorization query 28 as a question asking whether the cardholder authorizes the transaction, again either textually or vocally using the VRGS 76, and requesting a simple “yes/no” as the cardholder authorization response, which may be provided from a keypad of the CTD 42, 43 or vocally from the CTD 42, 43 and processed by the VRGS 76. Further, the cardholder may also choose to use a combination of a cardholder authorization code and a “yes/no” response. For example, the cardholder could choose that the ACD 12 require a “yes/no” response followed by entry of the cardholder authorization code to grant a cardholder authorization. Further, the cardholder may also elect to have an alarm generated by the ACD 12 and communicated to the financial institution in certain cases where the cardholder authorization is declined. Notably, for example, the cardholder could elect to have the ACD 12 send an alarm to the FIDB 18, for subsequent processing by the financial institution, and/or CDB 20 if the cardholder authorization code is not entered properly.

At step 140, the cardholder may also define, as the cardholder authorization query 28, a plurality of cardholder authentication questions and respective cardholder authentication answers therefore as part of the cardholder authentication response 26, all of which are stored in the CDB 20 in association with the card number 32. The cardholder authentication questions will typically be asked when a the cardholder communicates with the financial institution in the future, possibly by telephoning the ACD 12 or the FI, to make changes to any of the information previously provided in registration step 102 or to obtain information on the cardholder's records in the databases 18, 20. As such, a person designated by the FI, which will have access to the ACD 12, and responding to the call of the cardholder, will be able to ask one of the cardholder authentication questions and compare the response provided against the respective cardholder authentication answer 80 therefore. Should the answer provided by the cardholder to a given cardholder authentication question not match the cardholder authentication response, the FI will be alerted that the caller may not be the cardholder. Also, the cardholder authentication questions and answers 80 could also be deployed during cardholder authorization of transactions during steps 110 and cardholder pre-authorizations at step 103. Further, if desired, the ACD 12 can be configured to choose one of the cardholder authentication questions at random and cause it to be displayed, with the respective cardholder authentication response therefore, on a FICD 36 of the FI, the employee of the financial institution then being able to ask the cardholder authentication question 78 and evaluate the answer provided against the respective cardholder authentication answer.

Once the cardholder default limits 22, 23 and cardholder authorization queries 28 and responses 26 have been defined at steps 138 and 140, the employee of the financial institution, using the ACD 12, or the ACD 12 itself verifies, at step 142, whether the CTD 42, 43 is a cellular CTD 42 by checking the CTD type field 86. If the CTD 42, 43 is not a cellular CTD 42, i.e. the CTD 42, 43 is a landline CTD 43, then, proceeding to step 144, all information gathered during the steps 132, 134, 136, 138, 140 is stored on the CDB 20, if not already stored thereon and the registration is complete.

If the CTD 42, 43 is a cellular CTD 42, the ACD 12 automatically dials the respective telephone number 56 of cellular CTD to establish a telephonic connection therewith over the first network 40 at step 146. When the connection is established, the ACD 12 queries, again during step 146, the cellular CTD 42 for cellular CTD data 88, including the telephone serial number, manufacturer, and model number for the cellular CTD 42. When the ACD 12 receives the cellular CTD data 88, the ACD 12 stores the cellular CTD data 88 on the CDB 20. Then, proceeding to step 147, based on the telephone data 88, the ACD 12 programs the card number 24, as well as respective menu 55 therefor, into the cellular CTD 42. The menu 55 contains, among other things, at least one pre-authorization telephone number 56 which can be selected from the menu 55 and dialed from the cellular telephone 42 to establish a connection with the ACD 12 for pre-authorizing usage of the card 14, as explained below. Once the menu 55 is programmed, proceeding to step 148, the ACD 12 randomly generates an initial random CIC 92 of a plurality of characters, for example five numbers, which is stored in the CDB 20 associated with the respective phone number of the cellular CTD 42, as well as in the cellular CDT 42. This random CIC 92 is used for identifying the cellular CTD 42 at steps 103 and 110, as explained further below. Proceeding to step 144, all information gathered and generated during the steps 132, 134, 136, 138, 140, 146, and 148 is stored on the CDB 20, if not already stored thereon and the registration is complete.

It should be noted that, at any subsequent time, the cardholder may again contact the FI, or the ACD 12 in the event of automated changes or information requests, to change the information provided in the registration or to obtain information on the status of the card 14 or the cardholder's information stored in the databases 18, 20. For security and fraud prevention purposes, such changes may typically require, prior to acceptance of the changes or furnishing of any information to the cardholder, that the cardholder provide a cardholder authorization by providing at least one cardholder authorization responses 26 to a cardholder authorization query 28. Typically, for purposes of security, however, a cardholder will not be allowed to complete the registration or to modify the information provided therein from the cardholder cellular phone 50.

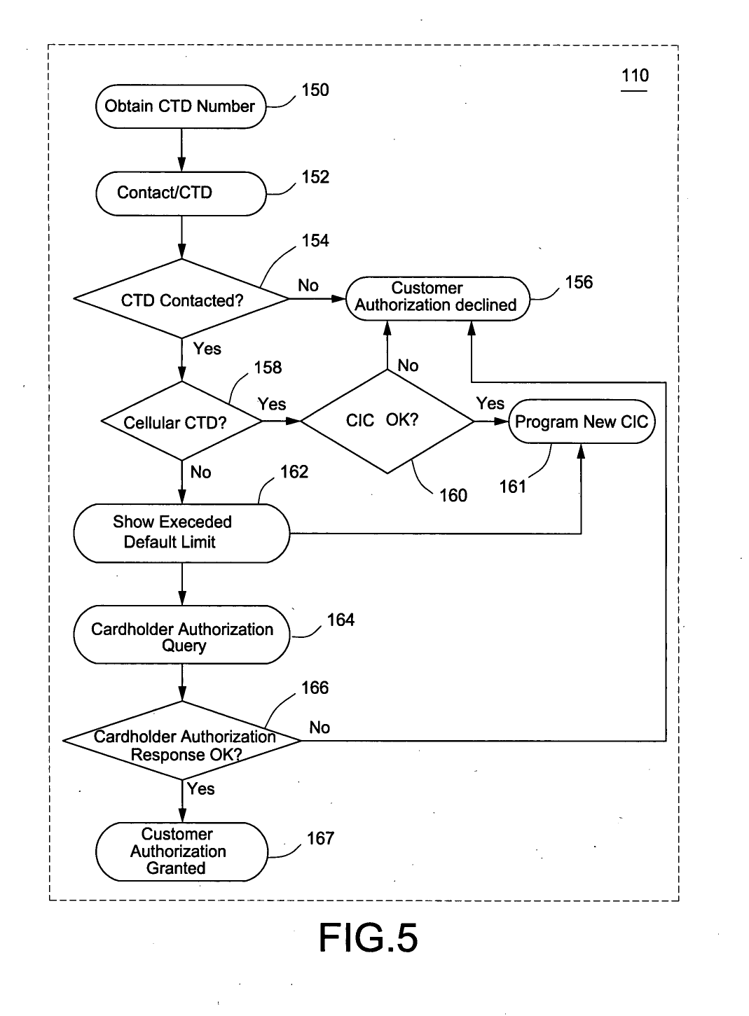

To better aid the reader in understanding step 110 in which the cardholder authorization is requested and verified, reference is now made to FIG. 5, in conjunction with FIGS. 1, 2, 3, and 4. When the card 14 is presented to a PTD 16 for usage, the PTD 16 contacts 14 the ACD 12 over the first network 40, preferably by dialing a respective telephone number for the ACD 12, and more specifically for the telephony interface 52 thereof, at step 149. When a connection between the ACD 12 and the PDT 16 is established, the PDT 16 queries, at step 104, the ACD 12 with the card number 24 to see if the usage was been pre-authorized at step 103. If the usage has not been preauthorized then, the cardholder authorization step 110 commences, at step 150, where the ACD 12 consults the CDB 20 and obtains the respective telephone number 56 of the cardholder CTD 42, 43 and which is associated with the card number 24 in the CDB 20. Proceeding to step 152, the ACD 12 dials the telephone number 56 of the CTD 42, 43 to establish a telephonic connection with the cardholder telephone 22 over the first network 40. At step 154, the ACD 12 verifies whether the ACD 12 has established a connection with the CTD 42, 43. If the connection is not established, for example there is no answer on the CTD 42, a voicemail on the CTD 42, 43 is activated or responds, or the CTD 42, 43 is busy, then the ACD 12 deems that the cardholder authorization has not been granted, i.e. the cardholder authorization is declined by the ACD 12, at step 156.

If, at step 154, the ACD 12 verifies that a connection between the ACD 12 and the CTD 42, 43 has been established, i.e. that the cardholder has chosen to respond to the call from the ACD 12, then, at step 158, the ACD 12 consults the CDB 20, and specifically the CTD type field 86, to determine whether the CTD 42, 43 is a cellular CTD 42. If the CTD type field 86 indicates that the CTD 42, 43 is a cellular CTD 42, then, at step 160, the ACD 12 verifies whether the cellular identification code CIC 92 stored on the cellular CTD 42 is the same as the valid CIC 92a stored on the CDB 20 for the CTD 42 and that the CIC 92 stored on the cellular CTD is not the same as an invalid CDC 92b associated with the telephone number 56 for the cellular CTD 42 in the CDB 20, the invalid CIC 92b being a CIC 92 that that has been recently assigned and verified by the ACD 12 during a previous connection between the ACD 12 and the cellular CTD 42. If the CIC 92 stored on the cellular CTD 42 is not the same as the valid CIC 92a stored in the CDB 20 or is the same as an invalid CIC 92b for the cellular CTD 42 stored in the CDB 20, then the cardholder authorization is declined at step 156. If the CIC 92 stored on the cellular CTD 42 is the same as the valid CIC 92a stored in the CDB 20 and is not the same as an invalid CIC 92b for the cellular CTD 42 stored in the CDB 20, then the cardholder authorization is declined at step 156. If the cellular character sequence 90 stored on the telephone 50 is the same as that stored in the valid code field 92 and not the same as any invalid CIC 92b stored in an invalid cellular code field 94, which indicates that a connection with the correct CTD 42 has been established, then, proceeding to step 161, the ACD 12 randomly generates a new CIC 92. Still at step 161, the ACD 12 then verifies that the new CIC 92 is not the same as the current valid CIC 92a or any invalid CIC 92b associated with the respective telephone number 56 for the cellular CTD 42 in the CDB 42, and will randomly generate new CIC 92 codes until the new CIC 92 generated is different from both the currently valid CIC 92a and any invalid CIC 92b. The current valid CIC 92a is then stored as an invalid CIC 92b for the CTD 42 in the CDB 20, and the new CIC 92, different from both the currently valid CIC 92a and any invalid CIC 92b, is stored as the valid CIC 92a for the cellular CTD 42. Still at step 161, the new CIC 92a is then is transmitted to the CTD 42 and stored thereon, replacing the existing CIC 92 stored thereon.

If the CTD 42, 43 is not a cellular CTD 42, or if the verification of the CIC 92 at step 160 is successful, then, at step 162, the ACD 12 sends a message to the CTD 42, 43 indicating the cardholder default limit 22, 23 that has been exceeded. More specifically, the ACD 12 sends a message to the CTD indicating the payment amount required for the usage and that the payment amount exceeds the cardholder default amount limit 22, or a message indicating the cardholder default periodic limit 23 and that the cardholder periodic limit 23 has been exceeded. The message can be either in text format, where the CTD 42, 43 has a display, or an automated vocal message vocal using the VRGS 76. Proceeding to step 164, the ACD 12 sends a message to the CTD 42, 43 presenting at least one cardholder authorization query 28 and requesting the respective cardholder authorization response 26 thereto, both query 28 and response 28 having been previously defined, and explained, at the registration step 102. Proceeding to step 166, the ACD 12 verifies that the cardholder respective authorization response 26 has been provided, i.e. that the response received from the CTD 42, 43 to the cardholder authorization query 28, matches the respective cardholder authorization response 26 stored on the CDB 20. If so, then the cardholder authorization is deemed to be granted by the ACD 12 at step 167. Otherwise, the cardholder authorization is declined at step 156. The granting or decline of the cardholder authorization is recorded in the CDB 20 and FIDB 18, as previously described at step 114 of FIG. 1.

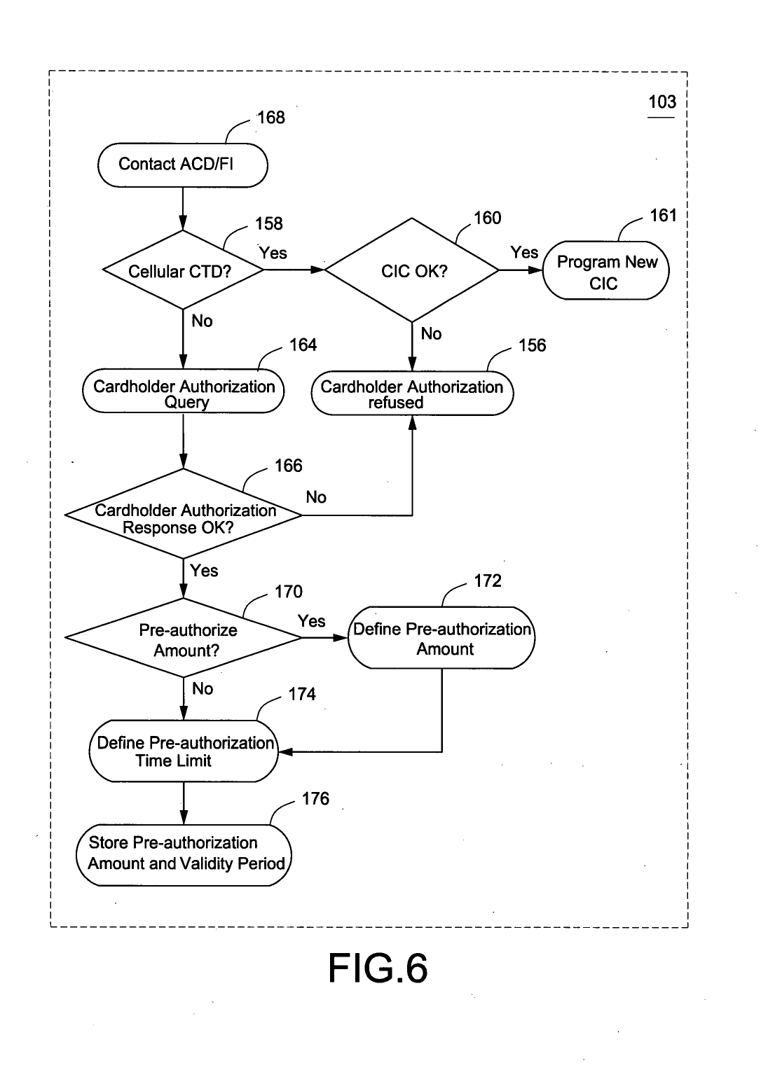

As described previously, the cardholder may, if desired, pre-authorize usage of the card that exceeds the cardholder default limits 22, 23 or deactivate the cardholder default limits 22 for a predetermined period of time at step 103, thereby overriding the limits 22, 23. To better aid the user in understanding the cardholder pre-authorization 104 step, reference is now made to FIG. 6, in conjunction with FIGS. 1, 2, 3, and 5. Commencing at step 168, when a cardholder wishes to pre-authorize usage of the card 14 beyond the cardholder default limits 22, 23 or to deactivate the cardholder default limits 22, the cardholder dials a pre-authorization telephone number 57 to connect to the ACD 12 or to the FICD 34, which will then route the call to the ACD 12. The pre-authorization telephone number 57 for cardholder pre-authorizations 99 may be dialed manually by the cardholder, or, in the case where the CTD 42, 43 is a cellular CTD 42, by selection by the cardholder of an option from the menu 55 programmed into the cellular CTD 42 at step 146. Once a connection between the ACD 12 and the cardholder telephone is established, then the cardholder must provide a cardholder authorization for the pre-authorized use. Accordingly, steps 156, 158, 160, 161, 162, 164, 166, 167 are performed as described previously, the pre-authorization being declined, should the cardholder authorization be declined at step 156. Should the cardholder authorization be granted at step 167, then the ACD 12, at step 170, sends a message to the cardholder telephone CTD 42, 43 requesting whether the cardholder wishes to pre-authorize a usage for payment up to a certain pre-authorization amount, which may exceed any of the default amount limit 22, 23. The cardholder then provides a response, still at step 170, confirming or denying that the cardholder desires the cardholder pre-authorization for a pre-authorization amount either using the keypad of the CTD 42, 43 or vocally, the latter being processed by the VRGS 76, if available. If the cardholder chooses to pre-authorize a usage up to a pre-authorization amount, then, proceeding to step 172, the ACD 12 sends a message to the CTD 42, 43 prompting the cardholder to enter the pre-authorization amount up to which the usage will be pre-authorized, preferably using the keypad of the CTD 42, 43. If the cardholder, at step 170, declines to specify a pre-authorization amount for the pre-authorization, then the ACD 12 will deem that a cardholder pre-authorization has been granted for any amount and that the default amount limit 22 has been overridden, although usage of the card will still be limited by verification at step 116 of any limits imposed by the financial institution.

Once the pre-authorization amount 98 for the cardholder pre-authorization has been specified at step 172, or if the cardholder declines to specify a pre-authorization amount for the cardholder pre-authorization at step 170, then the ACD 12 prompts the cardholder to enter a pre-authorization validity period 96 of time for which the pre-authorization will remain valid, again preferably using the cardholder telephone keypad at step 174. Once the pre-authorization validity period 96 is entered, then the pre-authorization validity period 96, as well as the pre-authorization amount 98 for the pre-authorization 99 is stored by the ACD 12 at step 176 as a cardholder pre-authorization, shown generally as 99. It should be noted that steps 156, 158, 160, 161, 162, 164, 166, 167 could also be performed after steps 170, 172, and 174.

To aid the reader in understanding how cardholder pre-authorizations 99 are handled during the authorization of the use of the card, reference is now again made to FIG. 1. As mentioned previously, at step 104, the ACD 12 verifies in the CDB 20 whether the cardholder pre-authorization 99 has been granted by verifying whether a pre-authorization validity period 96 or pre-authorization amount 98 has been defined for the card number in the CDB 20. More specifically, at step 104, the ACD 12 verifies whether the purchase amount for the usage is not above the pre-authorization amount 98 pre-authorized at steps 170 and 172. The ACD 12 also verifies that the pre-authorization validity period 96 specified at step 174 has not been exceeded. If both the amount pre-authorization amount 98 specified at steps 170 and 172 and the pre-authorization validity period 96 specified at step 174 are not exceeded, the ACD 12 proceeds directly to step 116. Otherwise, the ACD 12 proceeds to step 106, described previously.

It should be noted that connections between the ACD 12 and the celullar CTDs 42 for granting pre-authorizations 99 at step 103 and cardholder authorizations at step 110 need not necessarily be telephonic connections. For example, to the extent that the cellular CTD 42, 43 and ACD 12 are capable of non-telephonic connections, such as Internet connections, to one another over the network 40 and by which any data required for steps 103 and 110 may be transmitted therebetween, then such non-telephonic data connections may also be employed for granting cardholder authorizations and pre-authorizations 99.

While a specific embodiment has been described, those skilled in the art will recognize many alterations that could be made within the spirit of the invention, which is defined solely according to the following claims.

I claim:

1. A method for controlling usage of at least one cardholder payment card by a cardholder for purchases using a cardholder telephony device of the cardholder, the payment card being issued to the cardholder by a financial institution, said method comprising the steps of:
verifying that the usage does not exceed at least one cardholder default limit up to which a cardholder authorization for the usage is not required, each cardholder default limit being predefined by the cardholder;
if the at least one cardholder default limit is exceeded, requesting said cardholder authorization for the usage using the cardholder telephony device;
declining the usage if said cardholder authorization is not granted; and
if the usage is not otherwise declined by the financial institution, authorizing the usage.

2. The method of claim 1, wherein the at least one cardholder default limit comprises a cardholder amount limit defining, for each purchase usage, a maximum monetary value, predefined by the cardholder, for which the cardholder authorization is not required.

3. The method of claim 2, wherein said at least one pre-approved usage limit further comprises a default periodic limit defining, for a default period of time, a maximum default number of purchases for which the cardholder authorization is not required, the default period of time and the default number being predefined by the cardholder.

4. The method of claim 1, wherein said step of requesting the cardholder authorization comprises the steps of:
telephoning a respective telephone number of the cardholder telephony device to establish a telephonic connection therewith;
transmitting at least one cardholder authorization query to the cardholder telephony device requesting that the cardholder provide a response thereto from the cardholder telephony device;
receiving said response from the cardholder; and
based on said response, determining whether said cardholder authorization has been granted.

5. The method of claim 4, wherein said step of determining whether said cardholder authorization has been granted comprises the steps of:
comparing said response against a respective predefined cardholder authorization response associated with said cardholder authorization query;
if said response corresponds to said cardholder authorization response, deeming the cardholder authorization as being granted; and
if said response does not correspond to said cardholder authorization response, deeming the cardholder authorization to be refused.

6. The method of claim 5, wherein said at least one card authorization query and said respective card authorization response therefore are predefined by the cardholder.

7. The method of claim 4, wherein said response is provided by the cardholder vocally from said cardholder telephone.

8. The method of claim 4, wherein said response is provided by the cardholder from a keypad connected to said cardholder telephone.

9. The method of claim 5, wherein said cardholder authorization response is a cardholder authorization code predefined by the cardholder.

10. The method of claim 5, further comprising the step of informing, using said telephonic connection, the cardholder of said cardholder default limit that has been exceeded and of an amount associated with the purchase which has caused said cardholder default amount to be exceeded.

11. The method of claim 1, further comprising the steps of, prior to said step of verifying that the usage does not exceed at least one cardholder default limit:
storing a respective payment card number for the payment card in a first database;
storing a respective telephone number for the cardholder telephony device in said first database;
defining by said cardholder of said at least one cardholder default limit; and
storing said at least one cardholder default limit in said first database, wherein said cardholder default limit, said respective telephone number, and said cardholder default limit are associated with said card number in said first database, said first database being accessible by an authorization computing device connectable by a first network to the cardholder telephony device for requesting said cardholder authorization and accepting and declining said usage.

12. The method of claim 11, further comprising the steps of, prior to said step of verifying that the usage does not exceed at least one cardholder default limit:
defining by said cardholder of a cardholder authorization query and a respective cardholder authorization response therefor required for granting the cardholder authorization; and
storing said cardholder authorization query and said respective cardholder authorization response therefore in said first database.

13. The method of claim 1, further comprising the steps of:
requesting a financial institution authorization for the purchase from the financial institution; and
declining the usage if the financial institution declines to provide the financial institutional authorization.

14. The method of claim 1, further comprising the steps of, prior to said step of verifying that the usage does not exceed at least one cardholder default limit:
verifying whether the cardholder has granted a cardholder pre-authorization for usage of the card;
if the cardholder has granted said cardholder pre-authorization, verifying whether the usage exceeds a pre-authorization amount definable by the cardholder for the cardholder pre-authorization and whether the usage is requested in a preauthorized period of time defined by the cardholder for the cardholder pre-authorization;
if the usage does not exceed said pre-authorization amount and the usage is requested in said preauthorized period of time, omitting the steps of verifying that the usage does not exceed at least one cardholder default limit, requesting the cardholder authorization for the usage, and declining the usage, thereby overriding the cardholder default limit; and
if the cardholder has not granted said cardholder pre-authorization or if said pre-authorization amount is exceeded or if the usage is not requested in said preauthorized period of time, proceeding to said step of verifying that the usage does not exceed at least one cardholder default limit.

15. The method of claim 14, further comprising the steps of, prior to verifying whether the cardholder has granted a cardholder pre-authorization for usage of the card:
defining by the cardholder of said pre-authorization period of time for said cardholder pre-authorization from said cardholder telephony device.

16. The method of claim 15, further comprising the step of, prior to verifying whether the cardholder has granted a cardholder pre-authorization for usage of the card:
defining by the cardholder of said pre-authorization amount from the cardholder telephony device.

17. The method of claim 1, wherein said cardholder telephony device is a programmable cellular telephony device, and said step requesting the cardholder authorization comprises the steps of:
establishing a telephonic connection with said cellular cardholder telephony device;
using said telephonic connection, querying said cellular cardholder telephony device for a cardholder telephony device cellular identification code stored thereon;
comparing said cellular identification code against a valid cellular identification code stored in a first database;
deeming said cardholder authorization to be declined if said cellular identification code is not identical to said valid cellular identification code;
if said cellular identification code is identical to said valid cellular identification code, randomly generating a new cellular identification code, different from said valid identification code; and
storing said new identification code on said cellular as said cellular identification code and in said first database as said valid cellular identification code.

18. The method of claim 11, wherein the cardholder telephony device is a cellular cardholder telephony device, said method further comprising the steps of, prior to said step of verifying that the usage does not exceed at least one cardholder default limit:
establishing a telephonic connection with said cellular cardholder telephony device by dialing said respective telephone number therefor;
querying said cellular cardholder telephony device for cellular cardholder telephony device data using said the telephonic connection, said cellular cardholder telephony device data comprising a respective serial number therefor and respective model data defining a respective model and respective manufacturer therefor;
based on said model data, programming a respective menu for the payment card on said cellular cardholder telephony device using said telephonic connection, said respective menu comprising a respective pre-authorization telephone number for contacting said authorization computing device for granting a cardholder pre-authorization for the usage in excess of said cardholder default limit; and
storing said cellular cardholder telephony device data in said first database.

19. The method of claim 11, further comprising the step of, prior to said step of verifying that the usage does not exceed at least one cardholder default limit:
randomly generating a cardholder telephony device cellular identification code on said authorization computing device;
storing said cellular identification code as a valid cellular identification code in said first database; and
using said telephonic connection, storing said cellular identification code on said cellular cardholder telephony device.

20. A system for controlling usage of at least one cardholder payment card by a cardholder for purchases using a cardholder telephony device of the cardholder connected to a telephony enabled first network, said system comprising:
an authorization computing device for processing, the authorization computing device and the cardholder telephony device being connectable to one another by said first network; and
a first database accessible by said authorization computing device and containing a respective card number for the card and respective cardholder default limits for the card defined by the cardholder, said authorization computing device verifying that the usage does not exceed at least one cardholder default limit up to which a cardholder authorization for the usage is not required, requesting the cardholder authorization for the usage using the cardholder telephony device if the said cardholder default limit is exceeded, declining the usage if the cardholder authorization is not granted; and, if the usage is not otherwise declined by the financial institution, authorizing the usage.
